(19) United States
(12) Patent Application Publication
(10) Pub. No.: US 2008/0196669 A1
(43) Pub. Date: Aug. 21, 2008

(54) Animal Feeder

(76) Inventors: Jason Bryant, Sparta, TN (US); David Bryant, Sparta, TN (US)

Correspondence Address: PITTS AND BRITTIAN P C, P O BOX 51295, KNOXVILLE, TN, 37950-1295, US

(21) Appl. No.: 11/676,731

(22) Filed: Feb. 20, 2007

(51) Int. Cl. A01K 5/00

(52) U.S. Cl. 119/61.3

(57) ABSTRACT

A feeder for providing food to a plurality of animals comprises a generally horizontal base having a periphery. A central conical spreader is located above the base. An outer wall extends upwardly from said periphery of the base to an upper edge and defines a plurality of feeding apertures located to allow an animal to access feed located upon the base. A roof extends outwardly from the upper edge of the peripheral wall and over the feeding apertures. The roof defines a filling aperture located above the conical spreader. A door is adapted to selectively seal the filling aperture. Feed poured through the filling aperture is directed outwardly to the feeding apertures by the spreader to provide feeding animals with access through the feeding apertures to substantially all of the feed filled into the feeder.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to animal feeders.

More particularly, this invention pertains to improved animal feeders providing extended distribution of the feed to feeding apertures which are protected from precipitation.

2. Description of the Related Art

It is common provide food, in the form of grain or pellets, for example, to animals. Often the food is merely placed in open-top containers, such as buckets or boxes. These open-top containers suffer from allowing precipitation to fall into them, rapidly spoiling the food or, in cold weather allowing the feed to be frozen in ice and thus inaccessible to animals. Another detriment of the open-top container is that many animals will not share the food in an open top container with another animal. Accordingly, only one animal can feed at a single time

Improvements over the open-top container are provided by tubular bird feeders, for example, which provide a cover to deflect precipitation and multiple access apertures to feed stored within a single container. However, such feeders are often difficult to fill and, in the case of large volume feeders, the feed is not evenly proportioned among all of the feeding apertures.

In the case of larger animals which cannot comfortably feed from ground-based feeders, such as deer, for example, it is desirable to provide an elevated feeder. However, the height of the feeder varies with the sizes of the animals being fed. Accordingly, it is desirable to provide a feeder which is easily converted from one height to another height to accommodate differently sized animals.

### BRIEF SUMMARY OF THE INVENTION

According to one embodiment of the present invention, a feeder includes a base defining a central conical spreader, a peripheral wall defining a plurality of feeding apertures adapted to permit access within the peripheral wall, and a roof extending over the feeding apertures. A filling aperture is defined in the roof and located above the central conical section. A sealable door is adapted to selectively close the filling aperture.

Another embodiment provides a conical spreader which comprises an upper conical section and a coaxial, lower frustum section. A tubular wall extends between the lower frustum section and the upper conical section of the spreader. The tubular wall, the cross-section of which may vary from square to round, is adapted to slidingly receive a post for elevating the feeder to a desired height.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a feeder embodying various features of the present invention.

FIG. 2 is an elevation view of the feeder depicted in FIG. 1.

FIG. 3 is sectional elevation view taken along line 3-3 of FIG. 1.

FIG. 4 is a perspective view of another embodiment of a feeder embodying various features of the present invention.

FIG. 5 is an elevation view of the feeder depicted in FIG. 4.

FIG. 6 is sectional elevation view taken along line 6-6 of FIG. 4.

### DETAILED DESCRIPTION OF THE INVENTION

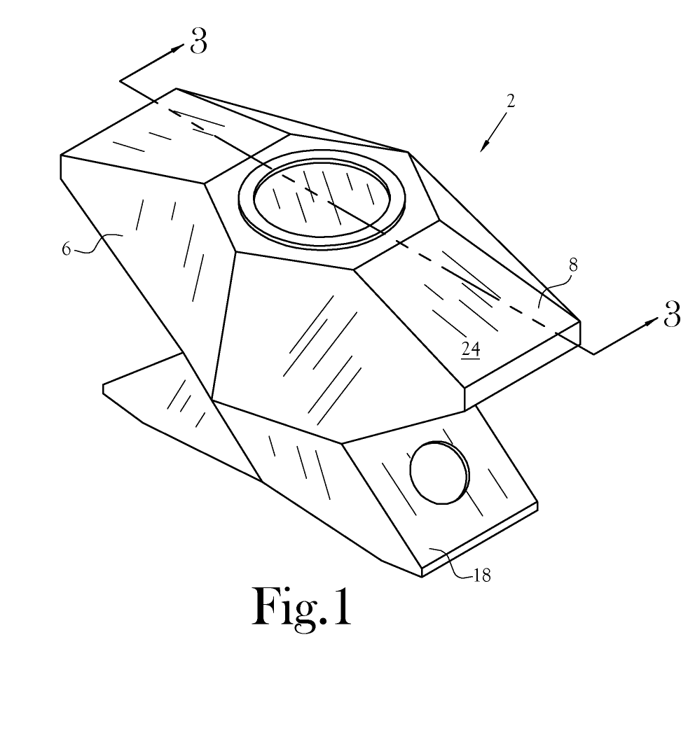

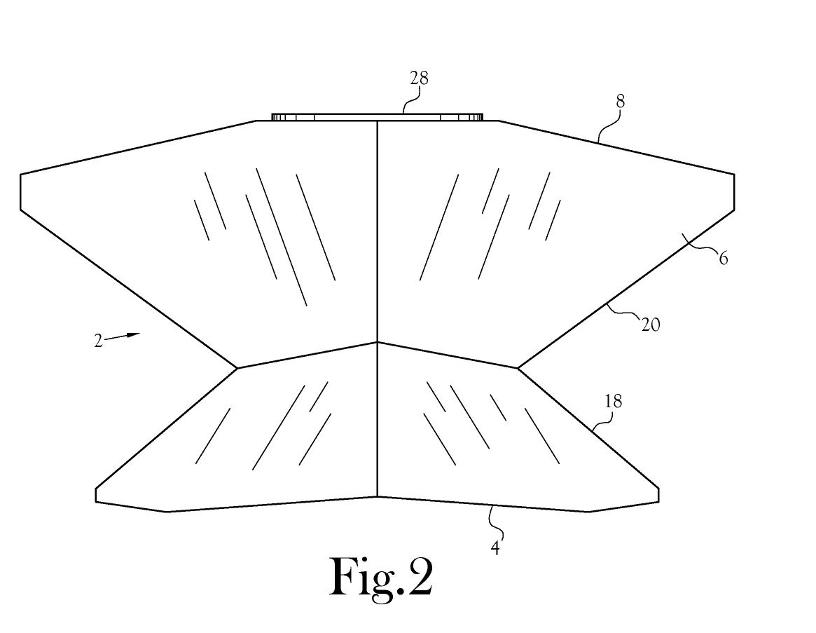

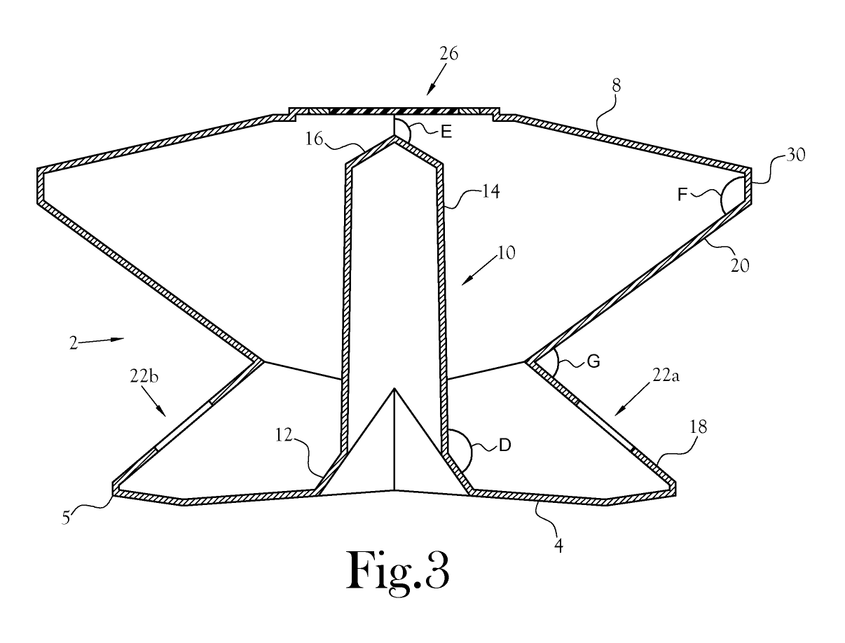

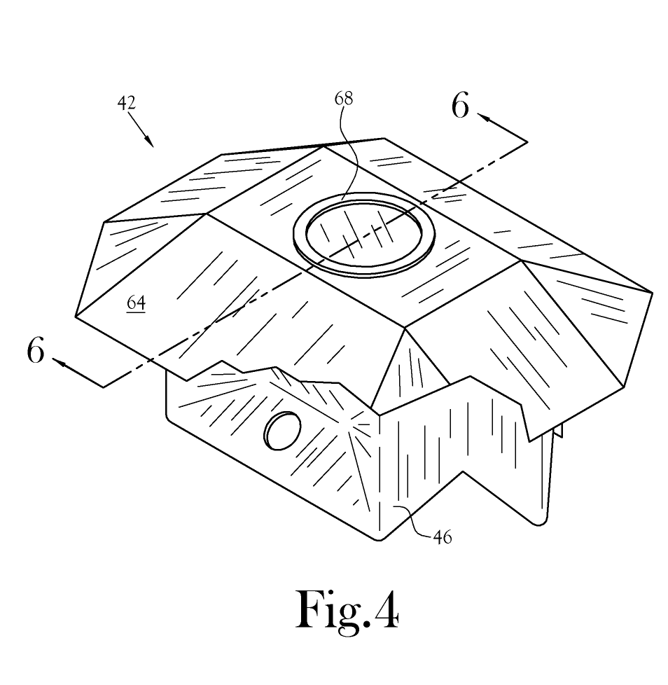

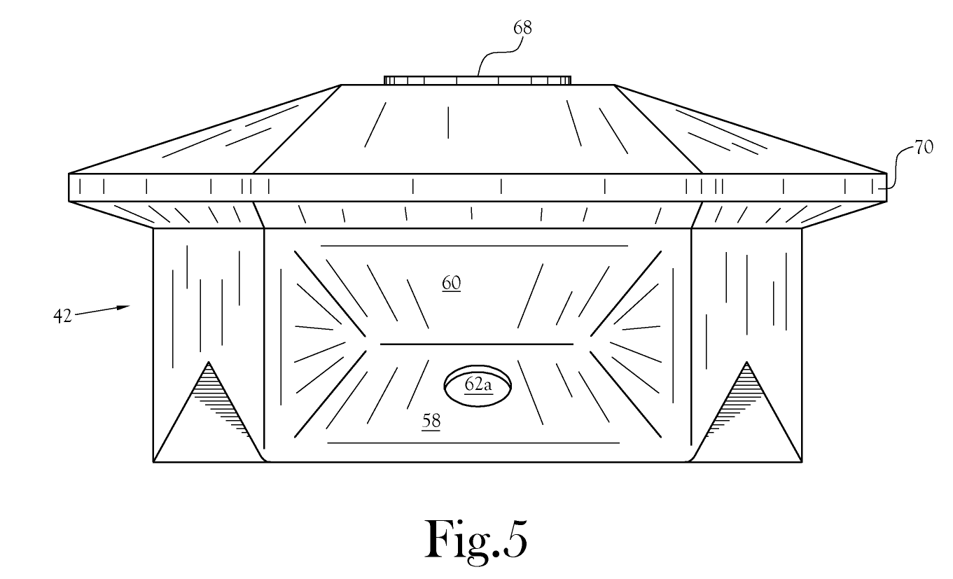

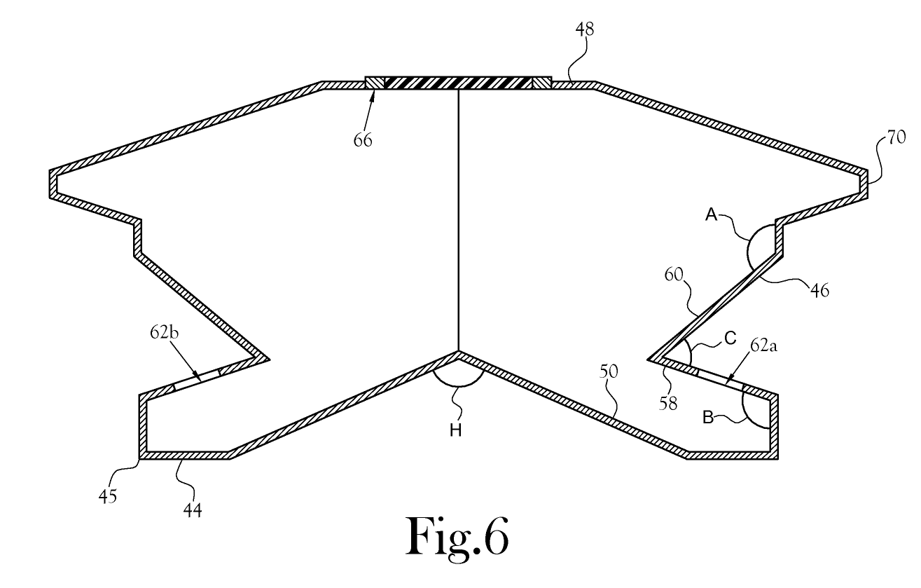

Referring to the drawings, in which like-numbered references correspond to like parts, one embodiment of a feeder in accordance with the present invention is depicted in FIGS. 1-3 and an alternative embodiment is depicted in FIGS. 4-6. Those skilled in the art will art will recognize that alternative embodiments can be used without departing from the spirit and scope of the present invention.

Referring to FIGS. 1-3, the feeder 2 comprises a base 4 having a peripheral edge 5, a peripheral wall 6 and a roof 8. The base 4 supports a spreader 10 comprising a frustum section 12 secured to the base, a tubular section 14 extending upwardly from the frustum section 12 and a conical section 16 capping the tubular section 14. The frustum section 12 and the tubular section 14 cooperatively define an angle D of about 110 degrees to about 160 degrees and preferably about 120 to about 150 degrees. The conical section 16 defies an angle E which is about 100 to about 150 degrees from vertical and preferably about 110 to about 140 degrees. The spreader 10 is centrally located on the base, generally equidistant from opposing portions of the peripheral side wall 6. The tubular section 14 is sized and shaped to slidably receive a post (not shown) to provide elevated mounting of the feeder 2.

The peripheral side wall 6 is generally V-shaped in cross-section, comprising a lower wall section 18 and an upper wall section 20. The lower wall section 18 and the upper wall section 20 cooperatively define an angle G of about 60 to about 110 degrees and preferably about 75 to 100 degrees. A plurality of feeding apertures 22a and 22b are defined in the lower wall section 18 to provide access for animals to remove food from within the feeder 2, down to the base 4.

The roof 8 defines a central filling aperture which is selectively sealed with a door 28. The roof 8 comprises a plurality of sloping top panels 24 extending outwardly from filling aperture to a generally vertical peripheral edge wall 30. The edge wall 30 is secured to the top of the upper wall section 20. The edge wall 30 and the upper wall section 20 cooperatively define an angle F of about 100 to about 160 degrees and preferably about 120 to about 150 degrees. The roof 8 extends outwardly beyond the base 4 to provide weather protection for the feeding apertures 22a and 22b.

With the exception of the door 28, the feeder 2 is preferably molded from a plastic material in a single piece.

In operation, the feeder 2 is slidably mounted upon a post inserted into the tubular section 14. The door 28 is removed from the filling aperture 26 and feed is poured through the filling aperture 26. As the feed strikes the conical section 16, it is directed down and outwardly to fill the feeder 2. The upper wall section 20 provides physical support for feed within the upper regions of the feeder 2, so that feed is not forced prematurely through the feeding apertures 22a and 22b. As animals remove food through the feeding apertures 22a and 22b, the feed is drawn downwardly by gravity. The angle of the upper wall section 20 directs the feed inwardly toward the tubular section 14 and the frustum section 12. The frustum section 12 directs the feed outwardly from the center of the feeder 2 toward the feeding apertures 22a and 22b. Animals are provided with access through the feeding apertures to substantially all of the feed filled into the feeder 2.

Referring to FIGS. 4-6, the feeder 42 comprises a base 44 having a peripheral edge 45, a peripheral wall 46 and a roof 48. The base 44 supports a conical spreader 50 extending upwardly from the base 44. The conical spreader 50 defies an interior angle H which is about 90 to about 160 degrees and preferably about 110 to about 140 degrees. The spreader 50 is centrally located on the base 44, generally equidistant from opposing portions of the peripheral side wall 46. The base is designed to be place upon the ground or on a raised platform

The peripheral side wall 46 is generally V-shaped in cross-section, comprising a lower wall section 58 and an upper wall section 60. The lower wall section 58 and the upper wall section 60 cooperatively define an angle C of about 60 to about 100 degrees and preferably about 70 to about 90 degrees. A plurality of feeding apertures 62a and 62b are defined in the lower wall section 58 to provide access for animals to remove food from within the feeder 42, down to the base 44. The feeding apertures 62a and 62b are oriented at an angle B which is about 100 to about 140 degrees from vertical and preferably about 100 to about 120 degrees from vertical.

The roof 48 defines a central filling aperture 66 which is selectively sealed with a door 68. The roof 48 comprises a plurality of sloping top panels 64 extending outwardly from filling aperture to a generally vertical peripheral edge wall 70. The edge wall 70 is secured to the top of the upper wall section 60. The edge wall 70 and the upper wall section 60 cooperatively define an angle A of about 100 to about 160 degrees and preferably about 120 to about 150 degrees. The roof 48 extends outwardly beyond the base 44 to provide weather protection for the feeding apertures 62a and 62b.

With the exception of the door 68, the feeder 2 is preferably molded from a plastic material in a single piece.

In operation, the feeder 42 is mounted upon the ground or on a platform, depending upon the height of the animals being fed. The door 68 is removed from the filling aperture 66 and feed is poured through the filling aperture 66. As the feed strikes the conical spreader 50, it is directed down and outwardly to fill the feeder 2. The upper wall section 60 provides physical support for feed within the upper regions of the feeder 44, so that feed is not forced prematurely through the feeding apertures 62a and 62b. As animals remove food through the feeding apertures 62a and 62b, the feed is drawn downwardly by gravity. The angle of the upper wall section 60 directs the feed inwardly toward the conical spreader 50, which in turn directs the feed outwardly from the center of the feeder 2 toward the feeding apertures 62a and 62b. Animals are provided with access through the feeding apertures to substantially all of the feed filled on the feeder base 44.

From the foregoing description, it will be recognized by those skilled in the art that various embodiments of improved animal feeders have been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A feeder for providing food to a plurality of animals comprising:
a generally horizontal base having a periphery;
a central conical spreader located above said base;
an outer wall extending upwardly from said periphery of said base to an upper edge and defining a plurality of feeding apertures located to allow an animal to access feed located upon said base;
a roof extending outwardly from said upper edge of said peripheral wall and over said feeding apertures, said roof defining a filling aperture located above said conical spreader; and
a door adapted to selectively seal said filling aperture;
whereby feed poured through said filling aperture is directed outwardly to said feeding apertures by said spreader to provide feeding animals with access through said feeding apertures to substantially all of said feed filled into said feeder.

2. The feeder of claim 1 wherein said feeding apertures are oriented at an angle of between about 100 to about 160 degrees from vertical.

3. The feeder of claim 1 wherein said outer wall is generally V-shaped in cross-section, comprising an upper wall section oriented at an angle of about 100 to 160 degrees from said roof.

4. The feeder of claim 1 wherein said conical spreader defines an angle of about 90 to about 160 degrees.

5. The feeder of claim 1 wherein said conical spreader defines an angle of about 110 to about 160 degrees.

6. The feeder of claim 1 wherein said conical spreader is integral with said base.

7. The feeder of claim 1 wherein said spreader comprises a frustum integral with said base, a tubular section extending upwardly from said frustum and a conical section atop said tubular section, said tubular section being adapted for sliding insertion upon a post.
